(19) United States
(12) Patent Application Publication
(10) Pub. No.: US 2010/0040219 A1
(43) Pub. Date: Feb. 18, 2010

(54) METHOD AND APPARATUS FOR PROCESSING NUMBER PORTABILITY CALL AMONG VARIOUS TELEPHONE NETWORKS

(75) Inventor: Young-Sic Jeong, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/442,247

(22) PCT Filed: Aug. 6, 2007
(86) PCT No.: PCT/KR2007/003771

§ 371 Date: Mar. 20, 2009

(30) Foreign Application Priority Data
Sep. 22, 2006 (KR) 10-2006-0092388
Dec. 5, 2006 (KR) 10-2006-0122636

(51) Int. Cl. H04M 7/00; H04L 12/66

(52) U.S. Cl. 379/221.13; 370/352

(57) ABSTRACT

An apparatus for processing a number portability call between homogeneous or heterogeneous telephone networks having a number portability supporting system (NPSS) and an implementation method thereof are provided. More particularly, provided are an apparatus and a method of supporting number portability, by which a number portability database (NPDB) for a variety of telephone networks is established in an NPSS, and number portability among wired telephone networks, mobile telephone networks, and voice over Internet protocol (VoIP) networks is commonly supported and processed. The apparatus for processing number portability includes: an NPSS formed using computer systems including an NPDB, a router for allowing access by wireline telephone companies, mobile communication companies or VoIP companies, and a number portability main server (NPMS); and computer systems and exchanges of telephone networks accessing the NPSS, querying the NPDB, or relaying and connecting a telephone call. Here, the number portability is a service allowing a telephone subscriber to change telephone service provider without changing an existing telephone number. According to the apparatus and method, a plurality of telephone networks can commonly access the NPSS and process a number portability call without building a local-NPDB, thereby minimizing investment cost for the number portability and facilitating maintenance.

### TECHNICAL FIELD

The present invention relates to a n apparatus for processing a number portability call between homogeneous or heterogeneous telephone networks having a number portability supporting system (NPSS) and an implementation method thereof, and more particularly, to a method and apparatus for supporting number portability, by which a number portability database (NPDB) for a variety of telephone networks is established in an NPSS, and number portability among wired telephone networks, mobile telephone networks, and voice over Internet protocol (VoIP) networks is commonly supported and processed.

### BACKGROUND ART

In general, in order to support number portability in conventional telephone networks, each telephone network service provider should have a local-number portability database (L-NPDB) in the company, and should perform a process of sending a query to the L-NPDB in the company in an originating network. The query may be based on an all call query (ACQ) method or a query on release (QoR) method. Only after performing these processes for processing a number portability call, can a recipient network be connected.

Here, the number portability is a service allowing a telephone subscriber to change telephone service providers without changing an existing telephone number.

FIG. 1 is a diagram illustrating an all call query (ACQ) method, which is a conventional method of supporting local number portability.

FIG. 1 relates to a conventional number portability call processing system, and illustrates that a number portability call is processed according to the ACQ method. According to the ACQ method, for each and every call, a number portability subscriber DB is first queried, and then, the call is directly connected to a recipient network. The ACQ method is mainly used for the case where there are many subscribers who have ported telephone numbers.

Referring to FIG. 1, first, an originating network 101 queries a local number portability DB (L-NPDB) 100 inside its company, determines a routing number of a recipient network 103, and by using the routing number, routes a number portability call to the recipient network 103. In this case, the call is not routed to a donor network 102 in advance.

For this type of system each telephone service provider requires a separate L-NPDB 100, and this means a substantial amount of investment, which has been an obstacle to the introduction of common number portability. Accordingly, the present invention suggests a concept of processing a number portability call in which a plurality of telephone networks for processing number portability are connected to a common number portability supporting system (NPSS) integrating and performing the number portability processing functions, and a method of implementing the concept.

FIG. 2 is a diagram illustrating a query on release (QoR) method, which is a conventional method of supporting local number portability.

FIG. 2 relates to a conventional number portability call processing system like that illustrated in FIG. 1, and illustrates that a number portability call is processed according to the QoR method. According to the QoR method, a call is routed to a donor network, and if it is confirmed that the number has been ported, the originating network queries a number portability DB, thereby connecting the call to a recipient network. The QoR method is used when there are not many subscribers who have ported telephone numbers.

Referring to FIG. 2, an originating network 201 first routes a call to a donor network 202, and if the donor network 202 sends a release message including number portability as the cause of the release, the originating network 201 queries an L-NPDB 200 inside its company, and connects the call to a resultant recipient network 203.

In this type of system, each telephone network service provider should introduce an L-NPDB, and this requires a substantial amount of investment. Also, the thus introduced L-NPDB requires considerable cost for the update and maintenance of information.

In particular, due to characteristics of the local DB, sharing of information is not sufficient, and thus a number portability support service demanded by subscribers may not be provided. Also, number portability information kept by each service provider may be private property, thereby forming antagonistic or hostile relationships between different telephone networks. Accordingly, accurate and reliable support of a number portability service that is essentially required by subscribers cannot be provided.

In order to solve this problem, an embodiment of the present invention suggests an NPSS allowing a variety of telephone network types, and a plurality of telephone networks, to access an NPDB in order to commonly use the NPDB.

### DISCLOSURE OF INVENTION

### Technical Problem

The present invention provides a system capable of providing number portability and a method of implementing the system, in which a number portability supporting system (NPSS) is commonly established among homogeneous or heterogeneous telephone networks, thereby providing number portability without building individual number portability DBs by telephone network service providers in order to process a number portability call.

According to the system and method, a plurality of telephone network service providers can use a common NPSS, and can build the NPSS supporting number portability between homogeneous or heterogeneous telephone networks, thereby providing number portability between a voice over Internet protocol (VoIP) service and a wired telephone, between a VoIP service and a mobile telephone, between a wired telephone and a mobile telephone, between VoIP services, between wired telephones, and between mobile telephones.

This can reduce investment cost or maintenance cost required when service providers separately build their respective NPDBs, and this can allow a plurality of telephone carriers to use a common NPSS, thereby providing number portability among a variety of telephone networks at a much cheaper method compared to the conventional systems.

### Technical Solution

According to an aspect of the present invention, there is provided an apparatus for processing a number portability call between homogeneous or heterogeneous telephone networks including: a number portability database (DB) storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and a number portability server receiving a query about recipient information of a predetermined telephone number from a variety of linked telephone networks, sending the query to the number portability DB, and providing recipient information that is a returned result of the query, to the telephone network.

According to another aspect of the present invention, there is provided a relay-type apparatus for processing a number portability call between homogeneous or heterogeneous telephone networks including: a number portability DB storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and a number portability server receiving a call from a variety of linked telephone networks, sending a query about a predetermined telephone number of the call to the number portability DB, and connecting the call to a recipient network, based on recipient information of the predetermined telephone number that is a returned result of the query.

According to another aspect of the present invention, there is provided a method of processing a call according to an all call query (ACQ) method in a number portability supporting apparatus for supporting number portability between homogeneous or heterogeneous telephone networks, the call processing method including: an originating network accessing a number portability supporting apparatus for supporting number portability between homogeneous or heterogeneous telephone networks, which is commonly used by a variety of telephone networks, and sending a query about a recipient network of a call that is desired to be connected; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network connecting the call to the recipient network, based on the routing number.

According to another aspect of the present invention, there is provided a method of processing a call according to a query on release (QoR) method in a number portability supporting apparatus for supporting number portability between homogeneous or heterogeneous telephone networks, the call processing method including: an originating network routing a call that is desired to be connected, to a donor network, by using a recipient number of the call as a routing number; if the recipient number of the call is ported out, receiving a release message from the donor network; the originating network, accessing a number portability supporting system for supporting number portability between homogeneous or heterogeneous telephone networks, which is commonly used by a variety of telephone networks, and sending a query about a recipient network of the recipient number; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network connecting the call to the recipient network, based on the routing number.

According to another aspect of the present invention, there is provided a method of processing a call according to an ACQ method in a relay-type number portability supporting apparatus for supporting number portability between homogeneous or heterogeneous telephone networks, the call processing method including: an originating network accessing a number portability supporting apparatus for supporting number portability between homogeneous or heterogeneous telephone networks, which is commonly used by a variety of telephone networks, and routing a call that is desired to be connected; sending a query about a recipient network based on the recipient number of the call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and the number portability supporting apparatus routing the call to the recipient network, based on a routing number for the recipient network that is a returned result of the query.

According to another aspect of the present invention, there is provided a method of processing a call according to a QoR method in a relay-type number portability supporting apparatus for supporting number portability between homogeneous or heterogeneous telephone networks, the call processing method including: an originating network routing a call that is desired to be connected, to a donor network, by using a recipient number of the call as a routing number; if the recipient number of the call is ported out, receiving a release message from the donor network; the originating network receiving the message, accessing a number portability supporting system for supporting number portability between homogeneous or heterogeneous telephone networks, which is commonly used by a variety of telephone networks, and routing the call that is desired to be connected; sending a query about a recipient network based on the recipient number of the routed call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and the number portability supporting apparatus routing the call to the recipient network, based on a routing number for the recipient network that is a returned result of the query.

According to another aspect of the present invention, there is provided a method of processing a short message service (SMS) message according to an ACQ method in a number portability supporting apparatus for supporting number portability between homogeneous or heterogeneous telephone networks, the SMS message processing method including: an originating network accessing a number portability supporting apparatus for supporting number portability between homogeneous or heterogeneous telephone networks, which is commonly used by a variety of telephone networks, and sending a query about a recipient network of an SMS message that is desired to be connected; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number for the recipient network of the SMS message that is a returned result of the query, to the originating network; and the originating network routing the SMS message to the recipient network, based on the routing number for the recipient network.

According to another aspect of the present invention, there is provided a method of processing an SMS message according to a QoR method in a number portability supporting apparatus for supporting number portability between homogeneous or heterogeneous telephone networks, the SMS message processing method including: an originating network routing an SMS message that is desired to be connected, to a donor network, by using a recipient number of the SMS message as a routing number; if the recipient number of the SMS message is ported out, receiving a release message from the donor network; the originating network receiving the message, accessing a number portability supporting system for supporting number portability between homogeneous or heterogeneous telephone networks, which is commonly used by a variety of telephone networks, and sending a query about a recipient network of the recipient number; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network routing the SMS message to the recipient network, based on the routing number.

### ADVANTAGEOUS EFFECTS

As described above, the present invention relates to a n apparatus for processing a number portability call between homogeneous or heterogeneous telephone networks having an NPSS and an implementation method thereof. The present invention suggests a system capable of providing number portability without building a separate NBPD for each telephone network service provider in order to process a number portability call, and a method of implementing the system. According to the system and method, investment cost or maintenance cost required by service providers when they individually build NPDBs, can be saved.

Also, the present invention supports number portability between heterogeneous telephone networks as well as between homogeneous telephone networks. Accordingly, number portability between a VoIP service and a wired telephone, between a VoIP service and a mobile telephone, between a wired telephone and a mobile telephone, between VoIP services, between wired telephones, and between mobile telephones can be provided. This allows use of a common NPSS by a plurality of telephone service providers, and enables number portability to be provided at a much cheaper price compared to conventional systems.

Since a plurality of telephone networks (VoIP networks, wired telephone networks, and mobile telephone networks) can access the NPSS by using dedicated lines or through the Internet and make queries to an NPDB at the same time, the cost of establishing a number portability call processing system is reduced and maintenance is facilitated.

In particular, in the case of small-sized VoIP service providers who want to provide number portability at a cheaper cost, the present invention can be used more efficiently.

### DESCRIPTION OF DRAWINGS

FIG. 1 is a diagram illustrating an all call query (ACQ) method, which is a conventional method of supporting local number portability;

FIG. 2 is a diagram illustrating a query on release (QoR) method, which is a conventional method of supporting local number portability;

FIG. 3 is a diagram illustrating a call processing system having a number portability database (NPDB)-type number portability supporting system (NPSS) for a variety of telephone networks according to an embodiment of the present invention;

FIG. 4 is a detailed diagram illustrating elements of the call processing system having the NPDB-type NPSS illustrated in FIG. 3 according to an embodiment of the present invention;

FIG. 5 is a diagram illustrating a call processing system having a relay-type NPSS for a variety of telephone networks according to an embodiment of the present invention;

FIG. 6 is a detailed diagram illustrating elements of the call processing system having the relay-type NPSS illustrated in FIG. 5 according to an embodiment of the present invention;

FIG. 7 is a diagram illustrating an ACQ-based number portability call processing system using an NPDB-type NPSS according to an embodiment of the present invention;

FIG. 8 is a flowchart of a method of processing an ACQ-based number portability call using an NPDB-type NPSS according to an embodiment of the present invention;

FIG. 9 is a diagram illustrating a QoR-based number portability call processing system using an NPDB-type NPSS according to an embodiment of the present invention;

FIG. 10 is a flowchart of a method of processing a QoR-based number portability call using an NPDB-type NPSS according to an embodiment of the present invention;

FIG. 11 is a diagram illustrating an ACQ/QoR-based number portability call processing system using a relay-type NPSS according to an embodiment of the present invention;

FIG. 12 is a flowchart of a method of processing an ACQ-based number portability call using a relay-type NPSS according to an embodiment of the present invention;

FIG. 13 is a flowchart of a method of processing a QoR-based number portability call using a relay-type NPSS according to an embodiment of the present invention;

FIG. 14 is a diagram illustrating a system for processing a number portability voice call according to a remote call forwarding (RCF) method, and processing a short message service (SMS) message and the like, according to an ACQ method by using an NPDB-type NPSS according to an embodiment of the present invention;

FIG. 15 is flowchart of a method of processing an SMS message according to an ACQ method by using an NPDB-type NPSS according to an embodiment of the present invention;

FIG. 16 is a diagram illustrating a system for processing a number portability voice call according to an RCF method, and processing an SMS message and the like, according to a QoR method by using an NPDB-type NPSS according to an embodiment of the present invention; and

FIG. 17 is flowchart of a method of processing an SMS message according to a QoR method by using an NPDB-type NPSS according to an embodiment of the present invention.

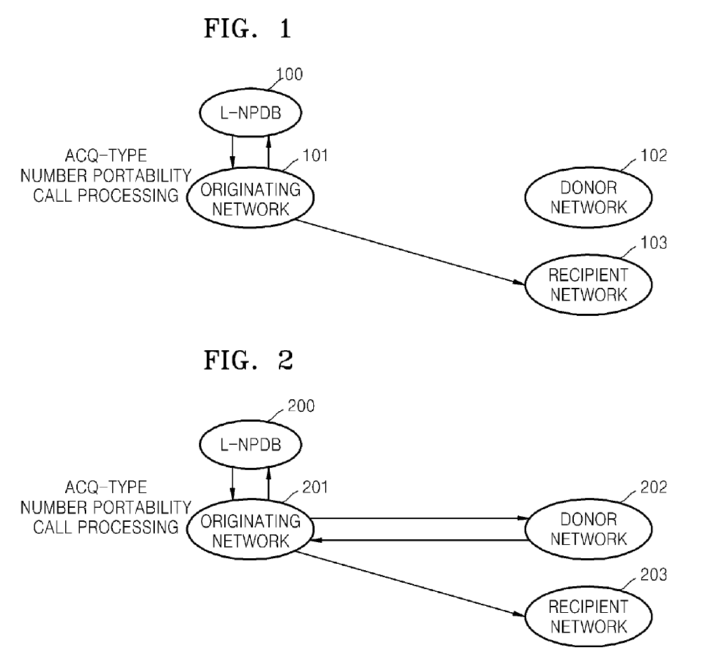

### BEST MODE

According to an aspect of the present invention, there is provided an apparatus for processing a number portability call between homogeneous or heterogeneous telephone networks including: a number portability database (DB) storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and a number portability server receiving a query about recipient information of a predetermined telephone number from a variety of linked telephone networks, sending the query to the number portability DB, and providing recipient information that is a returned result of the query, to the telephone network.

According to another aspect of the present invention, there is provided a relay-type apparatus for processing a number portability call between homogeneous or heterogeneous telephone networks including: a number portability DB storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and a number portability server receiving a call from a variety of linked telephone networks, sending a query about a predetermined telephone number of the call to the number portability DB, and connecting the call to a recipient network, based on recipient information of the predetermined telephone number that is a returned result of the query.

According to another aspect of the present invention, there is provided a method of processing a call according to an all call query (ACQ) method in a number portability supporting apparatus for supporting number portability between homogeneous or heterogeneous telephone networks, the call processing method including: an originating network accessing a number portability supporting apparatus for supporting number portability between homogeneous or heterogeneous telephone networks, which is commonly used by a variety of telephone networks, and sending a query about a recipient network of a call that is desired to be connected; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network connecting the call to the recipient network, based on the routing number.

According to another aspect of the present invention, there is provided a method of processing a call according to a query on release (QoR) method in a number portability supporting apparatus for supporting number portability between homogeneous or heterogeneous telephone networks, the call processing method including: an originating network routing a call that is desired to be connected, to a donor network, by using a recipient number of the call as a routing number; if the recipient number of the call is ported out, receiving a release message from the donor network; the originating network, accessing a number portability supporting system for supporting number portability between homogeneous or heterogeneous telephone networks, which is commonly used by a variety of telephone networks, and sending a query about a recipient network of the recipient number; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network connecting the call to the recipient network, based on the routing number.

According to another aspect of the present invention, there is provided a method of processing a call according to an ACQ method in a relay-type number portability supporting apparatus for supporting number portability between homogeneous or heterogeneous telephone networks, the call processing method including: an originating network accessing a number portability supporting apparatus for supporting number portability between homogeneous or heterogeneous telephone networks, which is commonly used by a variety of telephone networks, and routing a call that is desired to be connected; sending a query about a recipient network based on the recipient number of the call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and the number portability supporting apparatus routing the call to the recipient network, based on a routing number for the recipient network that is a returned result of the query.

According to another aspect of the present invention, there is provided a method of processing a call according to a QoR method in a relay-type number portability supporting apparatus for supporting number portability between homogeneous or heterogeneous telephone networks, the call processing method including: an originating network routing a call that is desired to be connected, to a donor network, by using a recipient number of the call as a routing number; if the recipient number of the call is ported out, receiving a release message from the donor network; the originating network receiving the message, accessing a number portability supporting system for supporting number portability between homogeneous or heterogeneous telephone networks, which is commonly used by a variety of telephone networks, and routing the call that is desired to be connected; sending a query about a recipient network based on the recipient number of the routed call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and the number portability supporting apparatus routing the call to the recipient network, based on a routing number for the recipient network that is a returned result of the query.

According to another aspect of the present invention, there is provided a method of processing a short message service (SMS) message according to an ACQ method in a number portability supporting apparatus for supporting number portability between homogeneous or heterogeneous telephone networks, the SMS message processing method including: an originating network accessing a number portability supporting apparatus for supporting number portability between homogeneous or heterogeneous telephone networks, which is commonly used by a variety of telephone networks, and sending a query about a recipient network of an SMS message that is desired to be connected; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number for the recipient network of the SMS message that is a returned result of the query, to the originating network; and the originating network routing the SMS message to the recipient network, based on the routing number for the recipient network.

According to another aspect of the present invention, there is provided a method of processing an SMS message according to a QoR method in a number portability supporting apparatus for supporting number portability between homogeneous or heterogeneous telephone networks, the SMS message processing method including: an originating network routing an SMS message that is desired to be connected, to a donor network, by using a recipient number of the SMS message as a routing number; if the recipient number of the SMS message is ported out, receiving a release message from the donor network; the originating network receiving the message, accessing a number portability supporting system for supporting number portability between homogeneous or heterogeneous telephone networks, which is commonly used by a variety of telephone networks, and sending a query about a recipient network of the recipient number; sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; transferring a routing number of the recipient network of the call that is a returned result of the query, to the originating network; and the originating network routing the SMS message to the recipient network, based on the routing number.

### MODE FOR INVENTION

An embodiment of the present invention relates a number portability call processing system having an NPSS for telephone networks, and a method of implementing the system. The present invention includes an NPSS formed by using computer systems including an NPDB, a router for telephone networks to access, and a number portability main server (NPMS), and computer systems and exchanges of telephone networks accessing the NPSS, querying the NPDB, or relaying and connecting a telephone call.

Also, an embodiment of the present invention is characterized in that number portability functions are integrated and processed in the NPSS. An embodiment of the present invention introduces the concept that a plurality of telephone networks access an NPSS and a number portability call is processed, a system for the concept, and a method of implementing the concept. Accordingly, if only a plurality of telephone service providers access the NPSS, each provider can process a number portability call without separately establishing an L-NPDB, thereby minimizing the investment cost of number portability and facilitating maintenance. Here, the telephone networks may be voice over Internet protocol (VoIP) networks, wired telephone networks or mobile telephone networks. Accordingly, more specifically, this NPSS can be used to provide number portability between a VoIP service and a wired telephone, between a VoIP service and a mobile telephone, and between a wired telephone and a mobile telephone.

The present invention will now be described more fully with reference to the accompanying drawings, in which exemplary embodiments of the invention are shown.

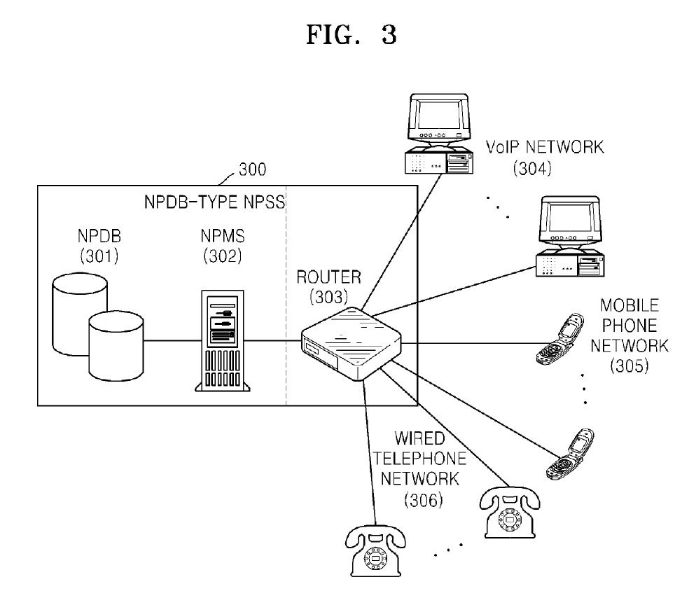

FIG. 3 is a diagram illustrating a call processing system having an NPDB-type NPSS for a variety of telephone networks according to an embodiment of the present invention.

Referring to FIG. 3, an NPDB-type NPSS 300 includes an NPDB 301 and an NPMS 302. The NPDB 301 stores recipient information which is changed with respect to an arbitrary telephone number, together with the arbitrary telephone number, when a service provider of a telephone service for the arbitrary telephone number is changed from a service provider of any one of a wired telephone network, a mobile telephone network, and a VoIP network, to another service provider of any one of the networks. The NPMS 302 receives queries about a predetermined telephone number from a variety of telephone networks connected to the NPSS 300, sends the queries to the NPDB, and provides recipient information that is a returned result of the queries, to the telephone networks.

Also, a router 303 is also included in the NPDB-type NPSS 300. The router 303 allows multiple access by the variety of telephone networks, receives queries about recipient information of a predetermined telephone number, and transfers the received queries to the NPMS 302. The router 303 allows multiple access by the variety of telephone networks by using dedicated lines or through the Internet.

The variety of telephone networks include a VoIP network 304 that is an Internet telephone network, a mobile telephone network 305, and a wired telephone network 306. In particular, when an originating network accessing the NPSS 300 is the VoIP network 304, a query to the NPSS 302 is formed using a predefined transmission control protocol/Internet protocol (TCP/IP) interface module, and the recipient information that is a returned result value of the query is provided in TCP/IP packets to the linked VoIP network. Here, the recipient information is a routing number indicating a recipient network of the inquired about telephone number.

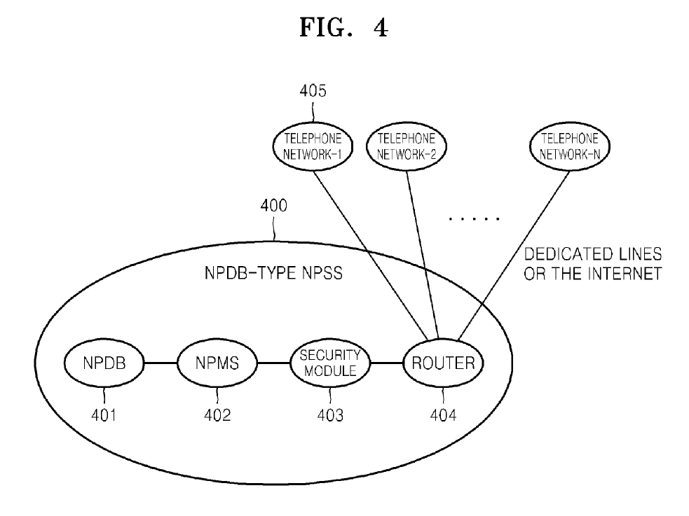

FIG. 4 is a detailed diagram illustrating elements of the call processing system having the NPDB-type NPSS illustrated in FIG. 3 according to an embodiment of the present invention.

Referring to FIG. 4, in addition to an NPDB 401 storing recipient information which is changed with respect to a ported telephone number, an NPMS 402 managing the NPDB, sending queries and providing inquired about recipient information, and a router 404 allowing a variety of telephone networks 405 to access the NPSS 400 and receiving queries, as described above with reference to FIG. 3, an NPDB-type NPSS 400 further includes a security module 403 for authenticating a telephone network accessing the router 404, and maintaining security of a query received by the router 404, thereby implementing a number portability call processing system for the variety of telephone networks 405.

The variety of telephone networks 405 are wired telephone networks, mobile telephone networks, and VoIP networks. These telephone networks access the router 404 by using dedicated lines or through the Internet.

More specifically, FIG. 4 illustrates a number portability call processing system having the NPDB-type NPSS 400 for telephone networks according to the current embodiment, which allows the plurality of telephone networks 405 to access the NPSS 400 and process number portability calls, unlike conventional number portability systems. For service providers accessing the router 404 inside the NPSS 400, the NPDB-type NPSS 400 performs the role of querying the NPDB 401 about a predetermined telephone number and providing a destination of the telephone number, that is, performs the role of a common DB.

A VoIP service provider or a wired telephone service provider is connected to the router 404 of the NPSS 400 by using dedicated lines or through the Internet, and the router 404 is connected to the NPMS 402 through the security module 404 at the back of the router 404. The NPDB 401 is connected to the NPMS 402. The plurality of telephone networks 405 can access the router 404. If a query about number portability information is sent to the NPSS 400 by using a predefined TCP/IP interface packet in order to inquire about number portability information, the query is transferred to the NPMS 402 through the router 404 and the security module 403.

Then, the NPMS 402 sends the query to the NPDB 401 and transfers a returned result value as number portability information, in TCP/IP packets to the inquiring telephone network 405.

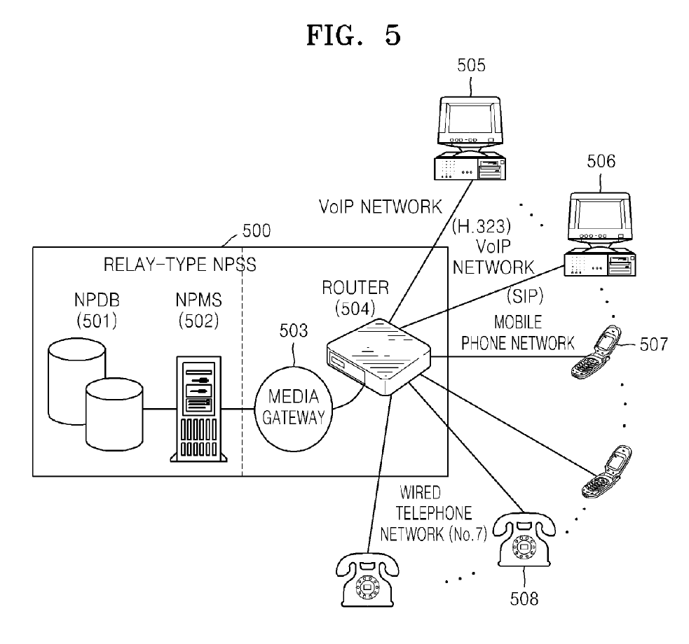

FIG. 5 is a diagram illustrating a call processing system having a relay-type NPSS for a variety of telephone networks according to an embodiment of the present invention.

Referring to FIG. 5, a relay-type NPSS 500 includes an NPDB 501 and an NPMS 502. The NPDB 501 stores recipient information which is changed with respect to an arbitrary telephone number, together with the arbitrary telephone number, when a service provider of a telephone service for the arbitrary telephone number is changed from a service provider of any one of a wired telephone network, a mobile telephone network, and a VoIP network, to another service provider of any one of the networks. The NPMS 502 receives a call received from a variety of telephone networks connected to the NPSS 500, queries the NPDB 501 about a predetermined telephone number of the call, and connects the call to a recipient network based on the recipient information of the predetermined telephone number that is a returned result of the query.

The NPSS 500 also includes a router 504 allowing multiple access of a variety of telephone networks and receiving a call that is desired to be connected, and a media gateway 503 converting the call into a format suitable for the protocol of the recipient network that is desired to be connected, based on the recipient information of the inquired about predetermined telephone number.

In particular, the media gateway 503 converts the call into a format complying with any one of the H.323 protocol, Session Initiation Protocol (SIP), and No. 7 signal network protocol that are protocols of a recipient network. Here, the variety of linked telephone networks include a wired telephone network 508, a mobile telephone network 507, and VoIP networks 505 and 506.

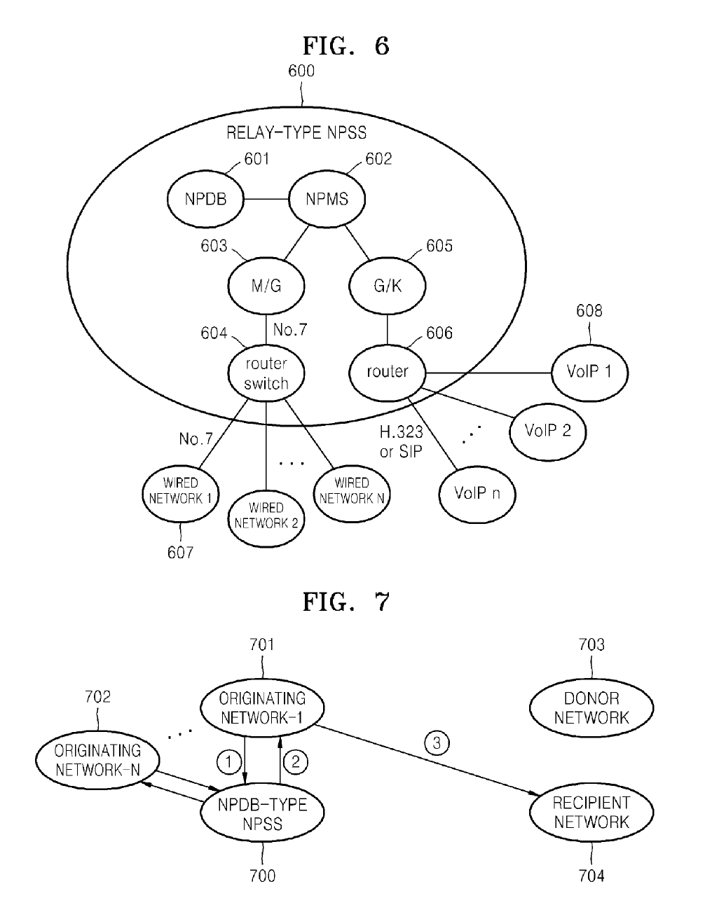

FIG. 6 is a detailed diagram illustrating elements of the call processing system having the relay-type NPSS illustrated in FIG. 5 according to an embodiment of the present invention.

Referring to FIG. 6, together with an NPDB 601 storing recipient information that is changed with respect to ported telephone numbers, an NPMS 602 managing the NPDB 601, querying about a received call, and connecting the call to a recipient network, a router 606 allowing access of a variety of telephone networks 607 and 608, and receiving a call, and a media gateway 603 converting a call into a format to fit the protocol of the recipient network that is desired to be connected, as described above with reference to FIG. 5, the relay-type NPSS 600 further includes a gate keeper 605 inquiring about a relationship between a predetermined telephone number and an Internet protocol (IP) address, or about an IP address of an originating network or a recipient network when a call received by the NPMS 602 is a VoIP call 608.

Also, by using a switch router 604, access to a plurality of telephone networks 607 is enabled. Here, recipient information is a routing number indicating the recipient network of the telephone number.

If a telephone network accessing the NPSS 600 is a wired network, the No. 7 signal protocol is used, and if the telephone network is a VoIP network 608, H.323 or SIP is used. However, if only the relay-type NPSS 600 is accessed by using a dedicated line or through the Internet, and a call is transferred to the relay-type NPSS 600, the relay-type NPSS 600 completes processes for connecting the call to a recipient network. In particular, if the linked telephone network is the VoIP network 608, a call of a predefined TCP/IP interface module is transferred to the relay-type NPSS 600.

More specifically, FIG. 6 illustrates a number portability call processing system having the relay-type NPSS 600 for VoIP and wired telephone services according to the current embodiment. If only a plurality of telephone networks access the relay-type NPSS 600 and a call is transferred, the relay-type NPSS 600 performs all the remaining processes, and thus connects the call to the recipient network. If a VoIP service provider accesses the relay-type NPSS 600, the relay-type NPSS 600 performs a function of converting between an H.323 protocol and SIP and between the H.323 or SIP and a No. 7 signal protocol. When a call is generated in a VoIP or wired telephone service, the NPSS 600 confirms the destination of the call according to the QoR or ACQ method, and connects the call to the destination.

The NPSS 600 can transfer the call generated in a wired telephone or mobile telephone, to a VoIP service provider, and can also transfer a call generated in a VoIP network to another telephone network (a VoIP network, a wired telephone network, or a mobile telephone network).

The NPSS 600 according to the current embodiment can convert a VoIP format, such as H.323 or SIP, to a format complying with a No. 7 signal protocol and vice versa. Accordingly, only by simply transferring a call to the relay-type NPSS 600, can a telephone network complete call processing to call connection at one time. As a result, a plurality of service providers do not need to pay the cost of number portability call processing and conversion of required protocols for connection between heterogeneous networks, thereby enabling a cheap number portability call processing system as a whole.

FIG. 7 is a diagram illustrating an ACQ-based number portability call processing system using an NPDB-type NPSS according to an embodiment of the present invention.

FIG. 7 illustrates the case where a number portability call is processed according to the ACQ method by using an NPDB-type NPSS 700.

Each of a plurality of originating networks 701 and 702 accesses the NPSS 700 and sends a query about a predetermined telephone number to an NPDB in operation 1. The NPSS 700 receiving the query sends the query to the NPDB inside the NPSS 700, and transmits a routing number indicating a recipient network 704 for the inquired about predetermined telephone number, to the originating network 701 in operation 2. The originating network 701 receiving the routing number routes a call to the recipient network 704 by using the routing number in operation 3.

In this case, the originating networks 701 and 702 or the recipient network 704 may be a VoIP network, a wired telephone network, or a mobile telephone network. The current embodiment is based on the ACQ method and thus does not route the call to a donor network 703 in advance.

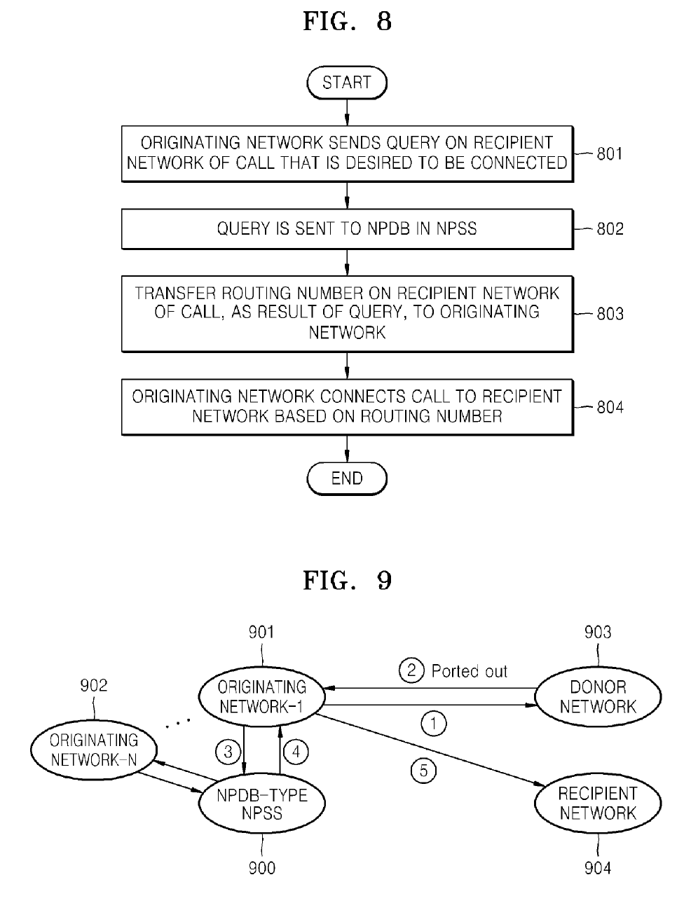

FIG. 8 is a flowchart of a method of processing an ACQ-based number portability call using an NPDB-type NPSS according to an embodiment of the present invention.

Referring to FIG. 8, first, an originating network accesses an NPSS for supporting number portability between homogeneous or heterogeneous telephone networks, which is commonly used by a variety of telephone networks, and queries about the recipient network of a call that is desired to be connected in operation 801. Then, in operation 802, the query is sent to an NPDB in the NPSS, which stores recipient network information that is changed with respect to an arbitrary telephone number when a service provider of a telephone service for the arbitrary telephone number is changed from a telephone network service provider to another service provider.

If a routing number for the recipient network of the call, which is a returned result of the query, is transferred to the originating network in operation 803, the originating network connects the call to the recipient network based on the routing number in operation 804. In this case, each of the originating network and the recipient network is one of a wired telephone network, a mobile telephone network, and a VoIP network.

In particular, when the originating network is a VoIP network, the query is formed using a predetermined TCP/IP interface module, and the routing number for the recipient network of the call is transferred in the form of a TCP/IP packet to the originating network.

FIG. 9 is a diagram illustrating a QoR-based number portability call processing system using an NPDB-type NPSS according to an embodiment of the present invention.

FIG. 9 illustrates the case where a number portability call is processed according to a QoR method by using an NPDB-type NPSS 900.

Referring to FIG. 9, an originating network 901 or 902 first routes a call to a donor network 903 in operation 1. If the routed telephone number of the call is ported out, the donor network 903 sends a release message with indicating number portability as the cause value in operation 2. At this time, the originating network 901 receiving the message that the telephone number is ported out accesses the NPSS 900 and requests the NPSS 900 to send a query about the predetermined telephone number to an NPDB in operation 3.

The NPSS 900 receiving the request to send a query to the NPDB sends the query to the NPDB inside the NPSS 900, and transmits a routing number indicating a destination that is a returned result of query about predetermined telephone number, to the originating network 901 in operation 4. The originating network 901 receiving the routing number routes the call to the recipient network 904 by using this routing number in operation 5. Here, each of the originating network 901 or 902 and the recipient network 904 may be a VoIP network, a wired telephone network, or a mobile telephone network.

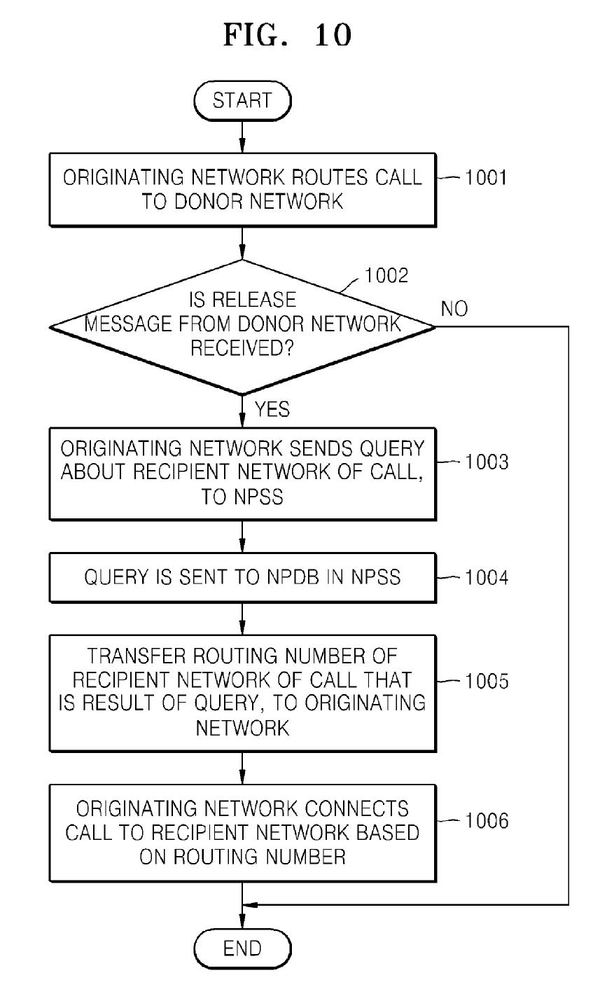

FIG. 10 is a flowchart of a method of processing a QoR-based number portability call using an NPDB-type NPSS according to an embodiment of the present invention.

Referring to FIG. 10, first, an originating network routes a call that is desired to be connected, to a donor network by using a recipient number of the call as a routing number in operation 1001. At this time, if the recipient number of the routed call is ported out, a release message from the donor network is received in operation 1002.

The originating network receiving the message accesses an NPSS for supporting number portability between homogeneous or heterogeneous networks, which is commonly used by a variety of telephone networks, and queries about the recipient network of the recipient number in operation 1003.

The NPSS receiving the query sends the query to an NPDB storing recipient network information that is changed with respect to a number portability supporting number in operation 1004. As a result, a routing number for the recipient network of the call is transferred as a returned result of the query, to the originating network in operation 1005. Then, the originating network connects the call to the recipient network based on the routing number in operation 1006.

Here, each of the originating network and the recipient network is one of a wired telephone network, a mobile telephone network, and a VoIP network.

In particular, after the donor network releases the routed call, the release message received from the donor network indicates that the cause of the release is porting of the recipient number.

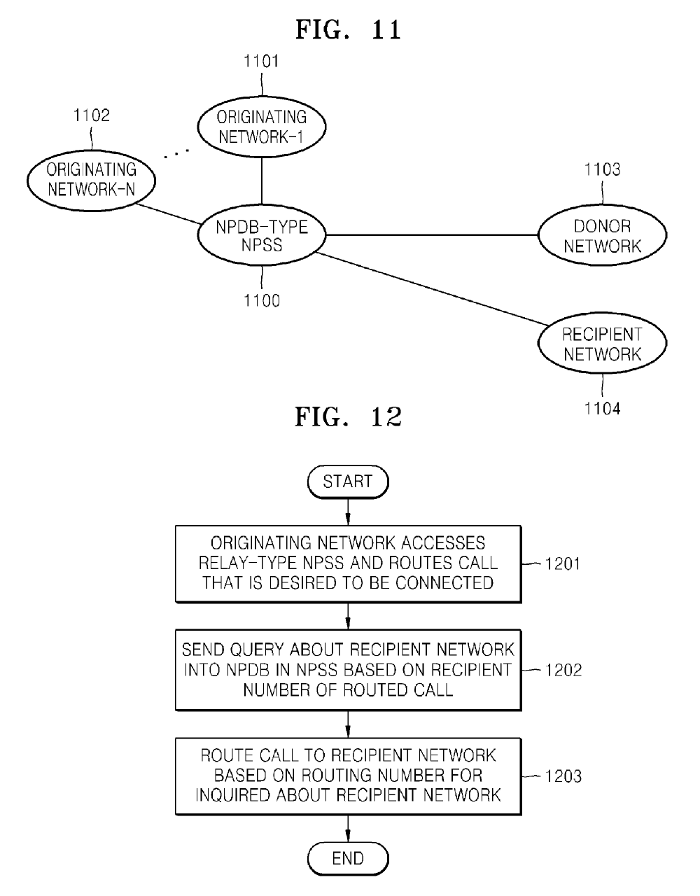

FIG. 11 is a diagram illustrating an ACQ/QoR-based number portability call processing system using a relay-type NPSS according to an embodiment of the present invention.

FIG. 11 illustrates the case where a number portability call is processed according to an ACQ/QoR method by using a relay-type NPSS 1100.

Referring to FIG. 11, if an originating network 1101 or 1102 routes a telephone call and the NPSS 1100 processes the call according to the ACQ method, a query is sent to an NPDB inside the NPSS 1100, routing number indicating a destination is confirmed, and then, by using this routing number, the call to a recipient network 1104 is routed.

Also, if the NPSS 1100 processes a call according to the QoR method, the call is first connected to a donor network 1003, and then, if a message indicating that the telephone number is ported out is received, a query is sent to the NPDB inside the NPSS 1100 and the call is routed to the recipient network 1004. Here, a plurality of telephone networks can access the NPSS 1100 and a number portability call and a call connection can be processed by the NPSS 1100. Each of the originating networks 1101 and 1102, the donor network 1103, and the recipient network 1104 may be a VoIP network, a wired telephone network, or a mobile telephone network.

FIG. 12 is a flowchart of a method of processing an ACQ-based number portability call using a relay-type NPSS according to an embodiment of the present invention.

Referring to FIG. 12, first, an originating network accesses an NPSS for supporting number portability between homogeneous or heterogeneous telephone networks, which is commonly used by a variety of telephone networks, and routes a call that is desired to be connected in operation 1201. Then, in operation 1202, a query about a recipient network based on a recipient number of the call is sent to an NPDB inside the NPSS, storing recipient network information that is changed with respect to an arbitrary telephone number when a service provider of a telephone service for the arbitrary telephone number is changed from a telephone network service provider to another service provider.

As a result, the NPSS routes the call to the recipient network based on a routing number for the inquired about recipient network in operation 1203. Here, each of the originating network and the recipient network is one of a wired telephone network, a mobile telephone network, and a VoIP network. In particular, if the originating network is a VoIP network, the routed call is a call of a predefined TCP/IP interface module.

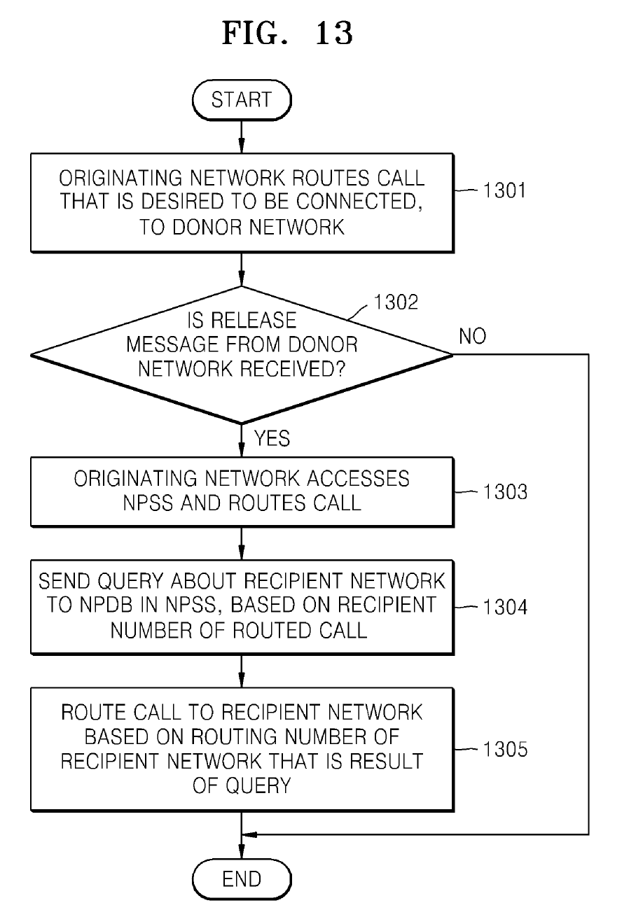

FIG. 13 is a flowchart of a method of processing a QoR-based number portability call using a relay-type NPSS according to an embodiment of the present invention.

Referring to FIG. 13, first, a call that is desired to be connected is routed to a donor network, by using a recipient number of the call as a routing number in operation 1301. If the recipient number of the call is ported out, a release message from the donor network is received in operation 1302. Then, the originating network receiving the message accesses an NPSS and routes the call that is desired to be connected in operation 1303. A query about the recipient network based on the recipient number of the routed call is sent to an NPDB inside the NPSS, storing information on the changed recipient network of the number portability telephone number in operation 1304. Then, the call can be routed to the recipient network based on a routing number for the recipient network that is a returned result value of the query in operation 1305.

Here, each of the originating network and the recipient network is one of a wired telephone network, a mobile telephone network, and a VoIP network. Also, after the donor network releases the routed call, the release message received from the donor network indicates that the cause of the release is the porting out of the recipient number.

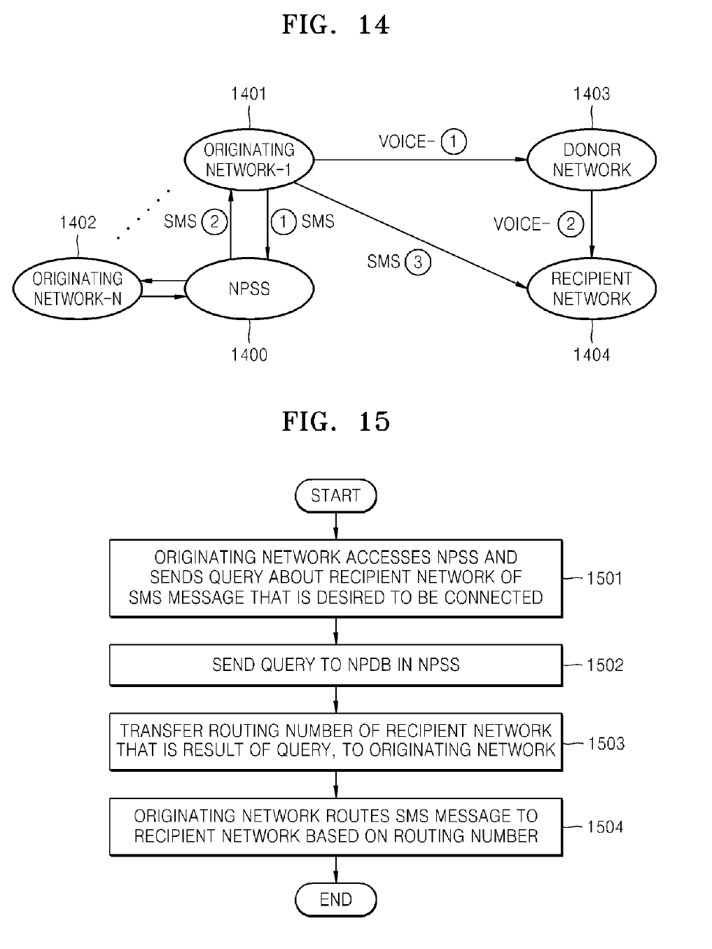

FIG. 14 is a diagram illustrating a system for processing a number portability voice call according to a remote call forwarding (RCF) method, and processing a short message service (SMS) message and the like, according to an ACQ method by using an NPDB-type NPSS according to an embodiment of the present invention.

The current embodiment is a method that can be applied when a number portability call of an SMS message cannot be processed according to the RCF method. According to the current embodiment, the RCF method is used to process a voice call, while the ACQ method using an NPSS is used to process an SMS message.

Referring to FIG. 14, in the case of a voice call, first, the voice call is routed to a donor network 1403 (voice 1), the donor network 1403 routes the call to a recipient network 1404 according to the RCF method (voice 2). In order to route an SMS message, an originating network 1401 sends a query to an NPSS 1400 (SMS 1), confirms the routing number of the recipient network 1404 (SMS 2), and by using the routing number, routes the SMS message to the recipient network 1404 (SMS 3).

Here, each of the originating networks 1401 and 1402, the donor network 1403, and the recipient network 1404 may be one of a VoIP network, a wired telephone network, and a mobile telephone network.

FIG. 15 is flowchart of a method of processing an SMS message according to an ACQ method by using an NPDB-type NPSS according to an embodiment of the present invention.

Referring to FIG. 15, first, an originating network accesses an NPSS for supporting number portability between homogeneous or heterogeneous networks, which is commonly used by a variety of telephone networks, and sends a query about a recipient network of an SMS message that is desired to be connected in operation 1501.

Then, in operation 1502, the query is sent to an NPDB inside the NPSS, which stores recipient network information that is changed with respect to an arbitrary telephone number when a service provider of a telephone service for the arbitrary telephone number is changed from a telephone network service provider to another service provider.

As a result, a routing number for the recipient network of the SMS message, which is a returned result of the query, is transferred to the originating network in operation 1503. The originating network routes the SMS message to the recipient network based on the routing number for the recipient network in operation 1504. Here, each of the originating network and the recipient network is one of a wired telephone network, a mobile telephone network, and a VoIP network. Also, if the originating network is a VoIP network, the query is formed using a predefined TCP/IP module, and the routing number for the recipient network, which is the returned result of the query is transferred as the TCP/IP packet to the originating network.

Here, a voice call related to the SMS message is transmitted according to an RCF method in which the call is transmitted via a donor network.

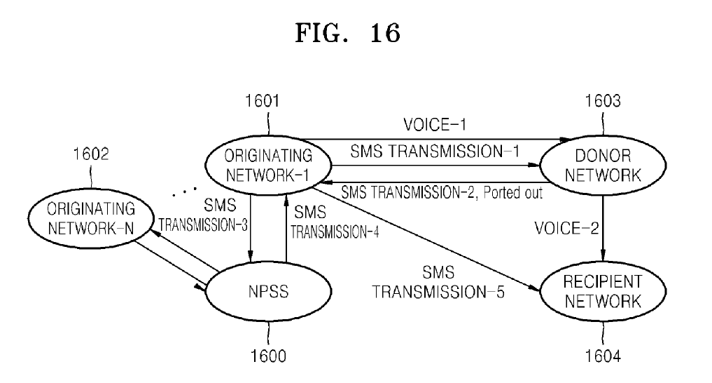

FIG. 16 is a diagram illustrating a system for processing a number portability voice call according to an RCF method, and processing an SMS message and the like, according to a QoR method by using an NPDB-type NPSS according to an embodiment of the present invention.

FIG. 16 illustrates the case where a number portability voice call is processed according to the RCF method, while an SMS message and the like is processed according to the QoR method by using an NPDB-type NPSS.

The current embodiment is a method that can be applied when a number portability call of an SMS message cannot be processed according to the RCF method. The RFC method is used to process a voice call, while the QoR method using the NPSS is used to process the SMS message. Referring to FIG. 16, a voice call is routed to a donor network 1603 (voice 1), and then, the donor network 1604 routes the call to a recipient network 1604 according to the RCF method (voice 2).

Meanwhile, an SMS message is first routed to the donor network 1603 (SMS transmission 1), and then, the donor network 1603 transmits a message indicating that the telephone number is ported out (SMS transmission 2). The originating network 1601 receiving this message sends a query to an NPSS 1600 (SMS transmission 3), finds out a routing number of the recipient network 1604 (SMS transmission 4), and by using this routing number, routes the SMS message to the recipient network 1604 (SMS transmission 5). Here, each of the originating networks 1601, and 1602, the donor network 1603, and the recipient network 1604 may be one of a VoIP network, a wired telephone network, and a mobile telephone network.

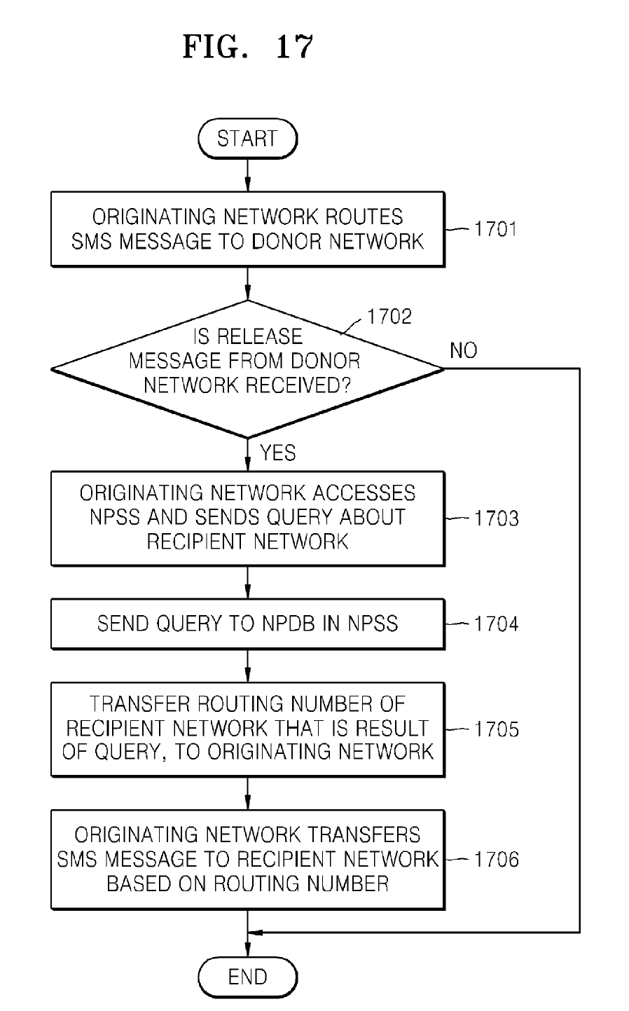

FIG. 17 is flowchart of a method of processing an SMS message according to a QoR method by using an NPDB-type NPSS according to an embodiment of the present invention.

Referring to FIG. 17, first, an SMS message that is desired to be connected is routed to a donor network, by using a recipient number of the SMS message as a routing number in operation 1701. Then, if the recipient number of the SMS message is ported out, a release message from the donor network is received in operation 1702.

The originating network receiving the message accesses an NPSS for supporting number portability between homogeneous or heterogeneous telephone networks, which is commonly used by a variety of telephone networks, and sends a query about a recipient network of the recipient number in operation 1703. In operation 1704, the query is sent to an NPDB storing recipient network information that is changed with respect to the telephone number when a service provider of a telephone service for the telephone number is changed from a telephone network service provider to another service provider. A routing number for the recipient network that is the returned result value of the query is transferred to the originating network in operation 1705.

Finally, the originating network routes the SMS message to the recipient network based on the received routing number in operation 1706. Here, each of the originating network and the recipient network is one of a VoIP network, a wired telephone network, and a mobile telephone network.

After the donor network releases the routed call, the release message received from the donor network indicates that the cause of the release is the porting out of the recipient number, and the voice call related to the SMS message is transmitted according to an RCF method in which the call is transmitted through the donor network.

As described above, the present invention relates to a n apparatus for processing a number portability call between homogeneous or heterogeneous telephone networks having an NPSS and an implementation method thereof. The present invention suggests a system capable of providing number portability without building a separate NBPD for each telephone network service provider in order to process a number portability call, and a method of implementing the system. According to the system and method, investment cost or maintenance cost required by service providers when they individually build NPDBs, can be saved.

Also, the present invention supports number portability between heterogeneous telephone networks as well as between homogeneous telephone networks. Accordingly, number portability between a VoIP service and a wired telephone, between a VoIP service and a mobile telephone, between a wired telephone and a mobile telephone, between VoIP services, between wired telephones, and between mobile telephones can be provided. This allows use of a common NPSS by a plurality of telephone service providers, and enables number portability to be provided at a much cheaper price compared to conventional systems.

Since a plurality of telephone networks (VoIP networks, wired telephone networks, and mobile telephone networks) can access the NPSS by using dedicated lines or through the Internet and make queries to an NPDB at the same time, the cost of establishing a number portability call processing system is reduced and maintenance is facilitated.

In particular, in the case of small-sized VoIP service providers who want to provide number portability at a cheaper cost, the present invention can be used more efficiently.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

The preferred embodiments should be considered in descriptive sense only and not for purposes of limitation. Therefore, the scope of the invention is defined not by the detailed description of the invention but by the appended claims, and all differences within the scope will be construed as being included in the present invention.

1. An apparatus for processing a number portability call between homogeneous or heterogeneous telephone networks comprising:
a number portability database (DB) storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and
a number portability server receiving a query about recipient information of a predetermined telephone number from a variety of linked telephone networks, sending the query to the number portability DB, and providing recipient information that is a returned result of the query, to the telephone network.

2. The apparatus of claim 1, wherein the changed recipient information stored in the number portability DB is a routing number for a recipient network of the telephone number.

3. The apparatus of claim 1, further comprising a router allowing multiple access of a variety of telephone networks, receiving a query about recipient information of a predetermined telephone number, and transferring the received query to the number portability server.

4. The apparatus of claim 3, further comprising a security module authenticating a telephone network accessing the router or maintaining security of the query received by the router.

5. The apparatus of claim 3, wherein the router allows multiple accesses to the router from the variety of telephone networks by using dedicated lines or through the Internet.

6. The apparatus of claim 1, wherein the telephone network linked to the number portability server is a VoIP network.

7. The apparatus of claim 6, wherein the query received by the number portability server is a query formed using a predefined transmission control protocol/Internet protocol (TCP/IP) interface module, and the recipient information that is the returned result of the query is provided as a TCP/IP packet to the linked VoIP network.

8. The apparatus of claim 1, wherein the variety of telephone networks linked to the number portability server are one or more networks from among wired telephone networks, mobile telephone networks, and VoIP networks.

9. A relay-type apparatus for processing a number portability call between homogeneous or heterogeneous telephone networks comprising:
a number portability DB storing recipient information that is changed with respect to an arbitrary telephone number when a service provider of a telephone service for the arbitrary telephone number is changed from a service provider of any one of a wired telephone network, a mobile telephone network, and a voice over Internet protocol (VoIP) network, to another service provider of any one of the networks; and
a number portability server receiving a call from a variety of linked telephone networks, sending a query about a predetermined telephone number of the call to the number portability DB, and connecting the call to a recipient network, based on recipient information of the predetermined telephone number that is a returned result of the query.

10. The apparatus of claim 9, further comprising:
a router allowing multiple access from a variety of telephone networks and receiving a call that is desired to be connected; and
a media gateway converting the call into a format complying with a protocol of the recipient network that is desired to be connected, based on the recipient information that is returned result of the query about predetermined telephone number.

11. The apparatus of claim 10, wherein the router allows multiple access to the router from the variety of telephone networks by using dedicated lines or through the Internet.

12. The apparatus of claim 10, wherein the protocol of the recipient network for which the media gateway converts the format of the call is any one of H.323, Session Initiation Protocol (SIP) and No. 7 signal network protocols.

13. The apparatus of claim 9, wherein the changed recipient information stored in the number portability DB is a routing number for a recipient network of the telephone number.

14. The apparatus of claim 9, wherein the telephone network linked to the number portability server is a VoIP network.

15. The apparatus of claim 14, wherein the call received by the number portability server is a call of a predefined TCP/IP interface module.

16. The apparatus of claim 9, if the call received by the number portability server is a VoIP call, further comprising a gate keeper inquiring about the correspondence relationship between the predetermined telephone number and an Internet protocol (IP) address, or an IP address of an originating network or a recipient network.

17. The apparatus of claim 9, wherein the variety of telephone networks linked to the number portability server are one or more networks from among wired telephone networks, mobile telephone networks, and VoIP networks.

18. A method of processing a call according to an all call query (ACQ) method in a number portability supporting apparatus for supporting number portability between homogeneous or heterogeneous telephone networks, the call processing method comprising:
an originating network accessing a number portability supporting apparatus for supporting number portability between homogeneous or heterogeneous telephone networks, which is commonly used by a variety of telephone networks, and sending a query about a recipient network of a call that is desired to be connected;
sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider;
transferring a routing number of the recipient network of the call that is a returned result of the query, to the originating network; and
the originating network connecting the call to the recipient network, based on the routing number.

19. The method of claim 18, wherein in the accessing of the number portability supporting apparatus and sending the query by the originating network, the originating network is a VoIP network.

20. The method of claim 19, wherein in the accessing of the number portability supporting apparatus and sending the query by the originating network, the query is formed using a predefined TCP/IP interface module, and in the transferring of the routing number, the routing number for the recipient network of the call is transferred in a TCP/IP packet, to the originating network.

21. The method of claim 18, wherein each of the originating network and the recipient network is one of a wired telephone network, a mobile telephone network, and a VoIP network.

22. A method of processing a call according to a query on release (QoR) method in a number portability supporting apparatus for supporting number portability between homogeneous or heterogeneous telephone networks, the call processing method comprising:
an originating network routing a call that is desired to be connected, to a donor network, by using a recipient number of the call as a routing number;
if the recipient number of the call is ported out, receiving a release message from the donor network;
the originating network, accessing a number portability supporting system for supporting number portability between homogeneous or heterogeneous telephone networks, which is commonly used by a variety of telephone networks, and
sending a query about a recipient network of the recipient number;
sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider;
transferring a routing number of the recipient network of the call that is a returned result of the query, to the originating network; and
the originating network connecting the call to the recipient network, based on the routing number.

23. The method of claim 22, wherein the originating network is a VoIP network.

24. The method of claim 23, wherein in the sending by the originating network of the query, the query is formed using a predefined TCP/IP interface module, and in the transferring of the routing number, the routing number for the recipient network is transferred in a TCP/IP packet, to the originating network.

25. The method of claim 22, wherein in the receiving of the release message from the donor network, the release message includes number portability of the recipient number as the cause that the donor network releases the call.

26. The method of claim 22, wherein each of the originating network and the recipient network is one of a wired telephone network, a mobile telephone network, and a VoIP network.

27. A method of processing a call according to an ACQ method in a relay-type number portability supporting apparatus for supporting number portability between homogeneous or heterogeneous telephone networks, the call processing method comprising:
an originating network accessing a number portability supporting apparatus for supporting number portability between homogeneous or heterogeneous telephone networks, which is commonly used by a variety of telephone networks, and routing a call that is desired to be connected;
sending a query about a recipient network based on the recipient number of the call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and
the number portability supporting apparatus routing the call to the recipient network, based on a routing number for the recipient network that is a returned result of the query.

28. The method of claim 22, wherein in the accessing of the number portability supporting apparatus and routing the call by the originating network, the originating network is a VoIP network.

29. The method of claim 28, wherein in the accessing of the number portability supporting apparatus and routing the call by the originating network, the routed call is a call of a predefined TCP/IP interface module.

30. The method of claim 27, wherein each of the originating network and the recipient network is one of a wired telephone network, a mobile telephone network, and a VoIP network.

31. A method of processing a call according to a QoR method in a relay-type number portability supporting apparatus for supporting number portability between homogeneous or heterogeneous telephone networks, the call processing method comprising:
an originating network routing a call that is desired to be connected, to a donor network, by using a recipient number of the call as a routing number;
if the recipient number of the call is ported out, receiving a release message from the donor network;
the originating network receiving the message, accessing a number portability supporting system for supporting number portability between homogeneous or heterogeneous telephone networks, which is commonly used by a variety of telephone networks, and routing the call that is desired to be connected;
sending a query about a recipient network based on the recipient number of the routed call, to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider; and
the number portability supporting apparatus routing the call to the recipient network, based on a routing number for the recipient network that is a returned result of the query.

32. The method of claim 31, wherein the originating network is a VoIP network, and the call is a VoIP call.

33. The method of claim 32, wherein in the routing of the call by the originating network, and in the routing of the call by the number portability supporting apparatus, the routed call is a call of a predefined TCP/IP interface module.

34. The method of claim 31, wherein in the receiving of the release message from the donor network, the release message includes number portability of the recipient number as the cause that the donor network releases the call.

35. The method of claim 31, wherein each of the originating network and the recipient network is one of a wired telephone network, a mobile telephone network, and a VoIP network.

36. A method of processing a short message service (SMS) message according to an ACQ method in a number portability supporting apparatus for supporting number portability between homogeneous or heterogeneous telephone networks, the SMS message processing method comprising:
an originating network accessing a number portability supporting apparatus for supporting number portability between homogeneous or heterogeneous telephone networks, which is commonly used by a variety of telephone networks, and sending a query about a recipient network of an SMS message that is desired to be connected;
sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider;
transferring a routing number for the recipient network of the SMS message that is a returned result of the query, to the originating network; and
the originating network routing the SMS message to the recipient network, based on the routing number for the recipient network.

37. The method of claim 36, wherein a voice call related to the SMS message is transmitted according to a remote call forwarding (RCF) method in which the call is transmitted via a donor network.

38. The method of claim 36, wherein in the accessing of the number portability supporting apparatus and sending of the query by the originating network, the originating network is a VoIP network.

39. The method of claim 38, wherein in the accessing of the number portability supporting apparatus and sending of the query by the originating network, the query is formed using a predefined TCP/IP interface module, and in the transferring of the routing number for the recipient network of the SMS message, to the originating network, the routing number for the recipient network that is the returned result of the query is transferred in a TCP/IP packet, to the originating network.

40. The method of claim 36, wherein each of the originating network and the recipient network is one of a wired telephone network, a mobile telephone network, and a VoIP network.

41. A method of processing an SMS message according to a QoR method in a number portability supporting apparatus for supporting number portability between homogeneous or heterogeneous telephone networks, the SMS message processing method comprising:
an originating network routing an SMS message that is desired to be connected, to a donor network, by using a recipient number of the SMS message as a routing number;
if the recipient number of the SMS message is ported out, receiving a release message from the donor network;
the originating network receiving the message, accessing a number portability supporting system for supporting number portability between homogeneous or heterogeneous telephone networks, which is commonly used by a variety of telephone networks, and sending a query about a recipient network of the recipient number;
sending the query to a number portability DB in the number portability supporting apparatus, the number portability DB storing recipient network information that is changed with respect to an arbitrary telephone number when a service provider of a telephone service for the arbitrary telephone number is changed from a service provider of a telephone network to another service provider;
transferring a routing number of the recipient network of the call that is a returned result of the query, to the originating network; and
the originating network routing the SMS message to the recipient network, based on the routing number.

42. The method of claim 41, wherein a voice call related to the SMS message is transmitted according to an RCF method in which the call is transmitted via a donor network.

43. The method of claim 41, wherein in the routing of the SMS message by the originating network, the originating network is a VoIP network.

44. The method of claim 43, wherein in the accessing the number portability supporting system and sending of the query by the originating network, the query is formed using a predefined TCP/IP interface module, and in the transferring of the routing number for the recipient network of the SMS message, to the originating network, the routing number for the recipient network that is the returned result of the query is transferred in a TCP/IP packet, to the originating network.

45. The method of claim 41, wherein in the receiving of the release message from the donor network, the release message includes number portability of the recipient number as the cause that the donor network releases the SMS message.

46. The method of claim 41, wherein each of the originating network and the recipient network is one of a wired telephone network, a mobile telephone network, and a VoIP network.
